(19) United States
(12) Patent Application Publication
(10) Pub. No.: US 2008/0096095 A1
(43) Pub. Date: Apr. 24, 2008

(54) Thermal battery with long life time and long shelf life

(76) Inventor: Dario R. Dekel, Ramat Yishay (IL)

Correspondence Address: Paul D. Greeley;Ohlandt, Greeley, Ruggiero & Perle, L.L.P., 10th Floor, One Landmark Square, Stamford, CT, 06901-2682, US

(21) Appl. No.: 11/903,597

(22) Filed: Sep. 24, 2007

(30) Foreign Application Priority Data
Sep. 26, 2006 (IL) 178314

(51) Int. Cl. H01M 6/36

(52) U.S. Cl. 429/48; 429/112

(57) ABSTRACT

A thermal battery comprises a plurality of stacked cells, each cell consisting essentially of: a) a first anode comprising lithium or a lithium compound; b) a second anode comprising a second anode material; c) an oxidizing agent in contact with said second anode; and, d) a low temperature electrolyte placed between said first and said second anode. The second anode material is preferably selected such that it does not develop a substantial electric potential difference relative to the first anode.

### FIELD OF THE INVENTION

The present invention relates to improved thermal batteries. More particularly the present invention relates to preventing storage self-discharge in thermal batteries.

### BACKGROUND

Thermal batteries are thermally activated primary batteries comprising a series of cells consisting of a lithium-based anode, a cathode, an electrolyte between the electrodes and a pyrotechnic heat source. At ambient temperatures, the electrolyte is a solid, nonconducting salt. When power is required from the battery, an internal pyrotechnic heat source is ignited providing then enough heat to melt the solid electrolyte, thus allowing electricity to be generated electrochemically for periods from a few seconds to an hour. Employing solid state electrolytes in thermal batteries prevents storage self-discharge due to low ionic diffusion coefficient in solids. Thermal batteries have, therefore, a good shelf-life, require no maintenance, and can tolerate physical abuse (such as vibrations or shocks) during their storage life. Thermal batteries are most often used for military applications such as missiles, torpedoes, bombs, dispersed munitions, fuses, space missions and for emergency-power situations such as those in aircraft or submarines.

Electrolytes used in thermal batteries usually melt at temperatures between about 350° C. and about 450° C., which require high amounts of pyrotechnic heating materials, and often cause a problem maintaining the high temperatures of the molten state. Melting the electrolyte in order to activate the battery requires significant periods of time from tens to hundreds of milliseconds.

Generally, thermal batteries operate for seconds or for minutes, up to tens of minutes. Ideas for longer operation life were propose in the prior art:

U.S. Pat. No. 5,770,329 incorporates the heat source in a cathode precursor wafer essentially Fe/KClO₄, that upon ignition transforms into a FeO electrically conducting cathode.

US 2003/0017382 introduces a superior all-lithium electrolyte, LiCl—LiBr—LiF eutectic composition with lowest melting temperature possible, as the lithium source that furnishes Li⁺ ions to the top surface of the cathode, where a good intercalation of Li⁺ ions and FeO takes place. Introducing all-lithium electrolytes as LiCl—LiBr—LiF, having higher melting and operation temperatures, instead of more conventional ones, i.e. LiCl—KCl, produces, however, a need for pyrotechnics and short discharge time due to early electrolyte solidification.

The drawback of the batteries disclosed in both U.S. Pat. No. 5,770,329 and US 2003/0017382 is in high melting point of the electrolyte, i.e., higher than about 350° C., resulting in relatively short operation times.

The need for light weight thermal batteries operating at lower temperatures and having longer operation times together with long shelf-life led to several solutions proposed in the prior art:

U.S. Pat. No. 4,117,207 offers an improved electrolyte of sodium tertrachloroaluminate with lower melting temperature in the range of 165° C.-250° C. However, due to the potential difference between the anode and cathode this low melting point of the electrolyte results in a substantial ion flow through the electrolyte and then in self-discharge of the battery. For this reason, battery shelf-life is considerably reduced.

H1983 discloses the use of a supercooled liquid electrolyte that may remain liquid even below 0° C. In the solid state, due to slow solid to solid reactions the electrolyte is highly resistive. Self-discharge for the same reasons mentioned above in relation to U.S. Pat. No. 4,117,207 takes place also in this type of battery.

Storage potential difference between the electrodes, which may rise to a value of about 2.3 volts, may cause a substantial reduction in capacity during battery storage if self discharge occurs, thereby reducing the battery shelf-life, power generation output and operation time in an activated state. U.S. Pat. No. 5,900,331 aims at solving the problem of thermal battery storage self-discharge by introducing an insulating (epoxy/polymeric) layer between the pyrotechnic heat source, essentially a Fe/KClO₄ homogenous mixture, and a steel cover positioned on top of the electrodes in a stack configuration, where the heat source is separated from the electrodes, and the cathode includes also the electrolyte. The temperature and 103 at 60° C. than without the layer.

The attempt to reduce storage self-discharge while introducing such highly electrically insulating polymeric demands adapting the process of manufacturing thermal batteries to include a further step of coating, which is evidently more time consuming and costly, and may cause short circuiting through the polymer layer. The apparatus thus offered, should also take into consideration stresses inflicted by mechanical vibrations or shocks, and therefore potential structural failure, and the strength of bonding between the epoxy insulating layer and the steel cover affected by physical properties as interfacial bond strength and difference in values of the coefficients of thermal expansion.

Undesirable release of toxic residues to the surroundings as a result of the burning of the polymeric resin insulator in the process of activation, as well as potentially acidic by-products of that burning may cause corrosion and fast degradation of the battery metallic container as well as other corrosion susceptible parts. Also, release of gases will cause an increase of internal pressure of the thermal battery. This requires increase of battery case thickness. Moreover, the melting temperature of the electrolyte remains high, regardless of the addition of new resin layer, then the operating life time for the battery remains short.

The present invention combines the benefits of long operation time upon ignition with practically zero storage self-discharge by using on one hand a low melt temperature electrolyte and on the other hand a unique configuration of the battery cell of two anodes having at most a minor electric potential difference between them.

It is, therefore, an object of the present invention to provide a thermal battery with no storage self-discharge that overcomes the drawbacks of the prior art.

It is another object of the present invention to provide a two-anode thermal battery comprising a heat-source, which is essentially part of the second anode and an electrolyte with lower working temperature.

It is another object of the present invention to provide a thermal battery with long operation time upon ignition.

It is still another object of the present invention to provide a thermal battery with an extended shelf-life.

It is still another object of the present invention to provide a light-weight small volume thermal battery.

It is still another object of the present invention to provide a thermal battery having a mechanically resistant configuration, and which does not emit gases inside the thermal battery or toxic residues to the surroundings upon ignition as well as corrosion inflicting products.

It is still another object of the present invention to provide a method for eliminating storage self-discharge in a thermal battery.

This and other goals and objects of the present invention will become apparent from the description and claims to follow.

### SUMMARY OF THE INVENTION

The present invention offers the benefits of both employing in a thermal battery a low-temperature electrolyte and at the same time eliminating the effect of storage self-discharge without having to introduce insulation of any kind or to modify the battery cell configuration.

According to a preferred embodiment of the present invention the thermal battery comprises a plurality of stacked cells, each cell consisting essentially of:

a) a first anode comprising lithium or a lithium compound;

b) a second anode comprising a second material having positive oxidation potential;

c) an oxidizing agent in contact with the second anode; and

d) a low temperature electrolyte placed between said lithium comprising anode and said second anode;

The second anode may be any material that does not develop a substantial electric potential difference relative to the first anode when incorporated in the cells, and that upon oxidation transforms into a cathode material, where in the process of transforming into its oxide form of that anode material performs as a pyrotechnic heat source, the oxidation reaction being essentially an exothermic heat generating reaction.

Conventional anode materials that may be employed in the present invention include but are not limited to iron, cobalt, nickel, copper, zinc, chromium, vanadium, manganese, tungsten, titanium, mixtures, alloys or metal containing complexes thereof or compounds comprising such elements, wherein such mixtures, alloys complexes and compounds do not develop or have some minor electric potential difference relative to the first anode, and transform upon exothermic oxidation into a cathode material.

The use of two anodes, having both positive oxidation potentials, wherein these oxidation potentials essentially have very close values, actually eliminates the potential difference between the electrodes, thus preventing charge carriers, electrons and ions, from flowing upstream or downstream the potential difference, respectively, and cause storage self-discharge of the battery.

The oxidizing agent is, on one hand, in contact with the second anode material (referred to hereinafter also as “anode material”), wherein by the term “contact” is also meant that the oxidizing agent and the anode material form a homogenous mixture, and react with each other only upon ignition. The reaction between the oxidizing agent and the anode material is an exothermic oxidation reaction, thus generating heat and transforming the anode material into its oxide form, the latter possessing cathode properties. The heat produced then serves to melt the electrolyte or at least initiate flow of ions in the electrolyte and between the two electrodes. The second product of the oxidation reaction is the oxide of the anode material having a positive reduction potential, which allows it to perform essentially as a cathode against the lithium anode. The oxidation reaction takes place for a short period of time of tens of milliseconds.

Unlike in U.S. Pat. No. 5,770,329 and US 2003/0017382, having a high-melt electrolyte, above about 350° C., the electrolyte of the battery of the present invention is a low-melt one, thus allowing an essentially longer operation life-time.

The melting temperature range of the electrolyte is essentially lower than conventional electrolyte melting temperature as, for example, that of LiCl—KCl, i.e., 352° C. Preferably, the temperature range is between 100° C. and 200° C.

In one preferred embodiment of the present invention the second anode material is a metallic element or an alloy of the above-mentioned metallic elements that does not develop a substantial electric potential difference when incorporated in the cells of the thermal battery.

In another preferred embodiment of the present invention the second anode comprises an oxidizing agent in a homogenous mixture with the anode material, which reacts with it upon ignition in an exothermic oxidation reaction.

In a further preferred embodiment of the present invention the oxidizing agent is a perchlorate salt or a mixture of such salts. Preferably, the oxidizing agent is selected from potassium perchlorate, lithium perchlorate, or their mixtures.

In still another preferred embodiment of the present invention the lowest melting point of a mixture comprising such constituents.

It is within the scope of the present invention to provide a method for eliminating storage self-discharge in a thermal battery, which is activated upon ignition of a pyrotechnic heat source. The method comprises two major steps:

1) Providing the thermal battery of the present invention, comprising a plurality of stacked cells, where each cell consists essentially of:

a) a first anode comprising lithium or a lithium compound;
b) a second anode comprising a second anode material;
c) an oxidizing agent in contact with said second anode; and
d) an electrolyte placed between said first and said second anode;
where the second anode does not develop a substantial electric potential difference relative to the first anode thereby preventing current flow between the two anodes during storage life.
   2) Incorporating the oxidizing agent in the second anode in a homogenous mixture, where the oxidizing agent reacting upon ignition with the second anode in an exothermic oxidation reaction, whereby the mixture essentially operates as a pyrotechnic heat source upon ignition.

The following comparative examples will further illustrate the invention.

### EXAMPLE 1

A first thermal cell comprises:
A cathode pellet (wt %): 70% FeS2, 25% LiF—LiCl—LiI (3.2, 13, 83.8 wt % respectively), 5% MgO. Total weight: 0.88 gr
A separator pellet (wt %): LiF—LiCl—LiI (3.2, 13, 83.8 wt % respectively)-55%, MgO-45%. Total weight: 1.12 gr.
An anode pellet (wt %): Li—Al alloy (80% Li-20% Al)-90%, LiF—LiCl—LiI (3.2, 13, 83.8 wt % respectively)-10%. Total weight: 0.56 gr
A pyrotechnic pellet (wt %): Fe-83%, KCl04-17%. Total weight: 1.94 gr.

The potential difference between the electrodes prior to activation and during the battery storage: 2 volts.

A second thermal cell comprises:
An anode pellet (wt %): Li—Al alloy (80% Li-20% Al)-90%, LiF—LiCl—LiI (3.2, 13, 83.8 wt % respectively)-10%. Total weight: 0.56 gr
A separator pellet (wt %): LiF—LiCl—LiI (3.2, 13, 83.8 wt % respectively)-55%, MgO-45%. Total weight: 1.12 gr.
A second anode pellet (wt %): Fe-85%, KCl04-15%. Total weight: 1.94 gr.

The potential difference between the electrodes prior to activation and during the battery storage: less than 0.01 volts.

### EXAMPLE 2

A first thermal cell comprises:
A cathode pellet (wt %): 70% FeS2, 25% LiCl—LiNO3 (12.6, 87.4 wt % respectively), 5% MgO. Total weight: 0.88 gr
A separator pellet (wt %): LiCl—LiNO3 (12.6, 87.4 wt % respectively)-55%, MgO-45%. Total weight: 1.12 gr.
An anode pellet (wt %): Li—Al alloy (80% Li-20% Al)-90%, LiCl—LiNO3 (12.6, 87.4 wt % respectively)-10%. Total weight: 6.56 gr
A pyrotechnic pellet (wt %): Fe-84%, KCl04-16%. Total weight: 1.94 gr.

The potential difference between the electrodes prior to activation and during the battery storage: 2.2 volts (meaning capacity loss during storage)

A second thermal cell comprises:
An anode pellet (wt %): Li—Al alloy (80% Li-20% Al)-90%, LiCl—LiNO3 (12.6, 87.4 wt % respectively)-10%. Total weight: 0.56 gr
A separator pellet (wt %): LiCl—LiNO3 (12.6, 87.4 wt % respectively)-A second anode pellet (wt %): Cu-83%, KCl04-17%. Total weight: 1.94 gr.

The potential difference between the electrodes prior to activation and during the battery storage: less than 0.01 volts.

All the above description has been provided for the purpose of illustration and is not intended to limit the invention other than as defined in the appended claims.

1. A thermal battery comprising a plurality of stacked cells, each cell consisting essentially of:
a) a first anode comprising lithium or a lithium compound;
b) a second anode comprising a second anode material;
c) an oxidizing agent in contact with said second anode; and
d) a low temperature electrolyte placed between said first and said second anode.

2. The thermal battery of claim 1, wherein the second anode material is selected such that it does not develop a substantial electric potential difference relative to said first anode.

3. The thermal battery of claim 2, wherein the second anode material is selected from iron, cobalt, nickel, copper, zinc, chromium, vanadium, manganese, tungsten, titanium, mixtures or alloys or metal containing complexes thereof or compounds comprising such elements.

4. The thermal battery of claim 1 wherein the oxidizing agent comprises at least one perchlorate salt.

5. The thermal battery of claim 4, wherein the salts comprise either one of potassium perchlorate (KClO₄), lithium perchlorate (LiClO₄), sodium perchlorate (NaClO₄), magnesium perchlorate (MgCl₂O₈), or mixtures thereof.

6. The thermal battery of claim, wherein the salt is KClO₄/LiClO4/NaClO4/MgCl2O8 or mixture thereof, the weight percent of said salt or their mixture being in the range of about 5 wt % and about 30 wt % of the total combined weight of said second anode and said oxidizing agent.

7. The thermal battery of claim 1, wherein the second anode and the oxidizing agent form a homogenous mixture.

8. The thermal battery of claim 7, wherein the oxidizing agent reacts with the material of the second anode upon ignition in an essentially exothermic oxidation reaction.

9. The thermal battery of claim 8, wherein the exothermic oxidation reaction transforms the second anode material into a cathode material with respect to the first anode.

10. The thermal battery of claim 1, wherein the electrolyte comprises lithium or lithium compounds.

11. The thermal battery of claim 1, wherein the electrolyte is a low-melting electrolyte.

12. The thermal battery of claim 11, wherein the melting temperature of the electrolyte is lower than about 350° C.

13. The thermal battery of claim 12, wherein the melting temperature of the electrolyte is between about 100° C. and about 200° C.

14. A method for eliminating storage self-discharge in a thermal battery, wherein said battery is activated upon ignition of a pyrotechnic heat source, said method comprising:
1) providing a thermal battery, said battery comprising a plurality of stacked cells, each cell consisting essentially of:
a) a first anode comprising lithium or a lithium compound;
b) a second anode comprising a second anode material;
c) an oxidizing agent in contact with said second anode; and
d) an electrolyte placed between said lithium comprising anode and said second anode;
wherein said second anode does not develop a substantial electric potential difference relative to said first anode, thereby preventing current flow between the two anodes during battery storage, and
2) incorporating said oxidizing agent in said second anode in a homogenous mixture, said oxidizing agent reacting upon ignition with said second anode in an exothermic oxidation reaction, whereby said mixture essentially operates as a pyrotechnic heat source upon ignition.

15. The method of claim 14, wherein said exothermic oxidation reaction takes place between about 1 millisecond and about 100 milliseconds.

16. The method of claim 14, wherein the second component transforms into its oxide form and said oxide form has a positive reduction potential essentially performing as an electrically conducting cathode material with respect to the first anode.

17. The method of claim 14, wherein the oxidizing agent comprises at least one perchlorate salt.

18. The thermal battery of claim 17, wherein the perchlorate salts are either one of potassium perchlorate (KClO₄), lithium perchlorate (LiClO₄), sodium perchlorate (NaClO₄), magnesium perchlorate (MgCl₂O₈), or mixtures thereof.

19. The thermal battery of claim 14, wherein the electrolyte melts upon ignition of the second anode.

20. The thermal battery of claim 19, wherein the electrolyte melts as a result of the exothermic oxidation reaction, the melting temperature of said electrolyte being essentially lower than 350° C.

21. The thermal battery of claim 20, wherein the melting temperature of the electrolyte is between about 100° C. and about 200° C.

22. The method of claim 14, wherein the second anode material is selected from iron, cobalt, nickel, copper, zinc, chromium, vanadium, manganese, tungsten, titanium, mixtures or alloys or metal containing complexes thereof or compounds comprising such elements.
